(19) United States
(12) Patent Application Publication
(10) Pub. No.: US 2009/0092438 A1
(43) Pub. Date: Apr. 9, 2009

(54) APPLICATOR, USE OF THE APPLICATOR AND METHOD FOR TOPICALLY ADMINISTERING A LIQUID BY MEANS OF THE APPLICATOR

(75) Inventors: Thorfinn Ege, Tranby (NO); Oscar Rosengren, Jonkoping (SE); Christian Malm, Jonkoping (SE); Robert Axelsson, Granna (SE)

Correspondence Address: WINSTON & STRAWN LLP;PATENT DEPARTMENT, 1700 K STREET, N.W., WASHINGTON, DC, 20006, US

(73) Assignee: SANTOSOLVE AS, Osolo (NO)

(21) Appl. No.: 12/282,775

(22) PCT Filed: Mar. 9, 2007
(86) PCT No.: PCT/IB2007/050794

§ 371 Date: Sep. 12, 2008

(30) Foreign Application Priority Data
Mar. 14, 2006 (EP) 06111137.3

(51) Int. Cl. B43K 7/00

(52) U.S. Cl. 401/209; 401/208

(57) ABSTRACT

An applicator adapted for applying a liquid from a source of liquid to the skin of an individual subject. The applicator includes a housing delimiting a chamber, and a roller rotatably mounted in the housing with an adhesion side extending into the chamber and a transfer side extending out of the chamber. A cylinder is attached to the housing, at least one outlet and one through hole which are formed in the wall of the cylinder, is connecting the cylinder to the source of liquid and to the chamber, respectively, with the through holes axially and angularly displaced in relation to each other. A slider is arranged for sliding between first and second positions in the cylinder, a recess is formed in the slider, and the recess communicates with the source of liquid in the first position of the slider via the at least one first through hole and with the chamber in the second position of the slider via the at least one second through hole. The applicator is suitable for administering accurate and reproducible doses of easy-flowing cosmetic or medical formulations to the skin of a human being.

The present invention relates to an applicator for applying a liquid from a source of liquid to the skin of an individual subject, comprising a housing delimiting a chamber, and a roller rotatably mounted in the housing with an adhesion side extending into the chamber and a transfer side extending out of the chamber.

The invention also relates to a use of the applicator and to a method for applying the liquid to the skin of the individual subject.

Creams and ointments held in tubes or jars are frequently administered directly upon the skin of e.g. a human being.

In most cases this method is, however not optimally accurate for applying cosmetic and medical formulations. In some cases, therefore the products are applied by means of applicators of different kinds.

Some of these applicators are adapted to apply formulations, which have a relatively high viscosity thereby making it possible to apply a comparatively thick layer at a time. Such applicators are however not able to dose the formulations with the accuracy often required. Another draw back of such formulations consists in that the skin of the person using the applicator need a relatively long time for absorbing the thick formulation layer and obtaining the desired effect. During the period of absorbing the thick layer of formulation, the skin will be wet with formulation with the consequence that said person in the meantime could not cover the treated area of the skin with his/hers clothes.

The patent publication WO 03/018102 describes an applicator for topically administering a pharmaceutical formulation to the skin of e.g. a person. This known applicator has a housing for containing a quantity of the formulation. A rotatably lead screw is longitudinal disposed within the housing. The lead screw is operatively connected to a piston and rigidly to a pinion placed at one end of the housing. The pinion and the lead screw is rotated by activation a button thereby displacing the piston against the other end of the housing so pharmaceutical formulation is discharged through an outlet opening in an applicator head for applying the formulation to the skin. This applicator is able to meter such formulations with a high degree of accurately. The construction of the applicator is however rather complicated and costly and functions furthermore not with the security normally required when applying cosmetic and medical formulations to the skin of e.g. e human being.

The above-mentioned disadvantages of the prior art applicators are according to the present invention remedied by,

in a first aspect of the invention providing an applicator of the kind mentioned in the opening paragraph for applying a cosmetic or medical formulation to the skin of e.g. a human being,
in a second aspect of the invention providing an applicator of the kind mentioned in the opening paragraph which is capable of
metering accurate and reproducible doses of a cosmetic or medical formulation,
in a third aspect of the invention providing an applicator of the kind mentioned in the opening paragraph which have a reliable function,
in a fourth aspect of the invention providing an applicator of the kind mentioned in the opening paragraph which is capable of administering an easy flowing cosmetic or medical formulation,
in a fifth aspect of the invention providing an applicator of the kind mentioned in the opening paragraph which has a simple and cheap construction,
in a sixth aspect of the invention providing an applicator of the kind mentioned in the opening paragraph which is easy to operate,
in an eight aspect of the invention providing an applicator of the kind mentioned in the opening paragraph which is arranged for being operated with one hand,
in a ninth aspect of the invention providing an applicator of the kind mentioned in the opening paragraph which can be operated without contaminating the hand with the formulation to be applied,
in a tenth aspect of the invention providing an applicator of the kind mentioned in the opening paragraph which in a gentle way is able to apply a cosmetic or medical formulation to the skin of e.g. a human being,
in an eleventh aspect of the invention providing an applicator of the kind mentioned in the opening paragraph where the construction is adapted to minimize the contamination of the liquid in the source of liquid.

The novel and unique features of the invention consist in the fact that that a pipe is attached to the housing, that at least one first—and one second through hole, which are formed in the wall of the pipe, is connecting the pipe to the source of liquid and to the chamber, respectively, that said through holes are axially and angularly displaced in relation to each other, that a slider is arranged for sliding between a first—and second position in the pipe, that a recess is formed in the slider, and that the recess is communicating with the source of liquid in the first position of the slider via the at least one first through hole and with the chamber in the second position of the slider via the at least one second through hole.

The construction of the applicator of the invention is simple and cheap and is capable to accurately applying e.g. an easy flowing cosmetic or medical formulation to the skin of e.g. a human being.

The accuracy of the metering of the formulation may be improved when a seal is arranged between the slider and the inner surface of the pipe for thereby totally preventing any leaking of formulation,

The applicator of the invention can easily be operated by means of one hand when the recess separates a front section and a back section of the slider, the front section partly is extending out of an opening at one end of the pipe and a pressure spring is acting between the second section and a bottom at the other end of the pipe.

The operator then only need to exercise a light pressure upon the free end of the front section of the slider and let it go again for supplying an accurate dose of formulation to the chamber of the housing.

Repeating of this operation will allow for the transfer of the number of doses required for obtaining the desired effect on the skin to be treated.

The recess in the slider may in its first position be filled with formulation via an outlet in the wall of the pipe between the source of formulation and the recess while air in the recess at the same time is displaced via a vent in the wall between the recess and the source of formulation.

The outlet may according to the invention be placed closer to the opening of the pipe than the vent and is debauching at a smaller distance from the inner side of the pipe for thereby obtaining a difference pressure and in this way effectively securing that formulation flows from the source of liquid to the recess of the slider via the outlet while air flows from the recess to the liquid in the bottle via the vent.

The formulating dosed into the chamber of the housing by manipulating the slider in the way described above is removed from the chamber when rolling the roller over the skin to be treated with the formulation.

This process takes place as the formulation in the chamber adheres to the adhesion side of the roller and the adhered formulation is transferred to the skin by means of the transfer side of the roller.

The terms adhesion side and transfer side means in this connection those area of the surface of the roller, which at a given moment is inside or outside the chamber, respectively.

Said areas may be defined by an edge region of a skirt which is formed on the housing in as said edge region is placed close to or is abutting the roller on the borderline between the adhesion side and the transfer side of the roller.

The position of the roller in relation to the housing may effectively be secured owing to the fact that the adhesion side of the roller is larger than the transfer side, and at least three pins at one end each is attached to the pipe and at the other end is close to or is abutting the roller.

It is important at least to minimize the contamination of the liquid in the source of liquid and that advantage is obtained by means of the special construction of the applicator according to the invention in as the seal around the back section of the slider functions as a barrier for contamination brought into the chamber of the housing when the roller is rolling of the skin of the user of the applicator.

The invention will be explained in greater detail below where further advantageous properties and example embodiments are described with reference to the drawings, in which

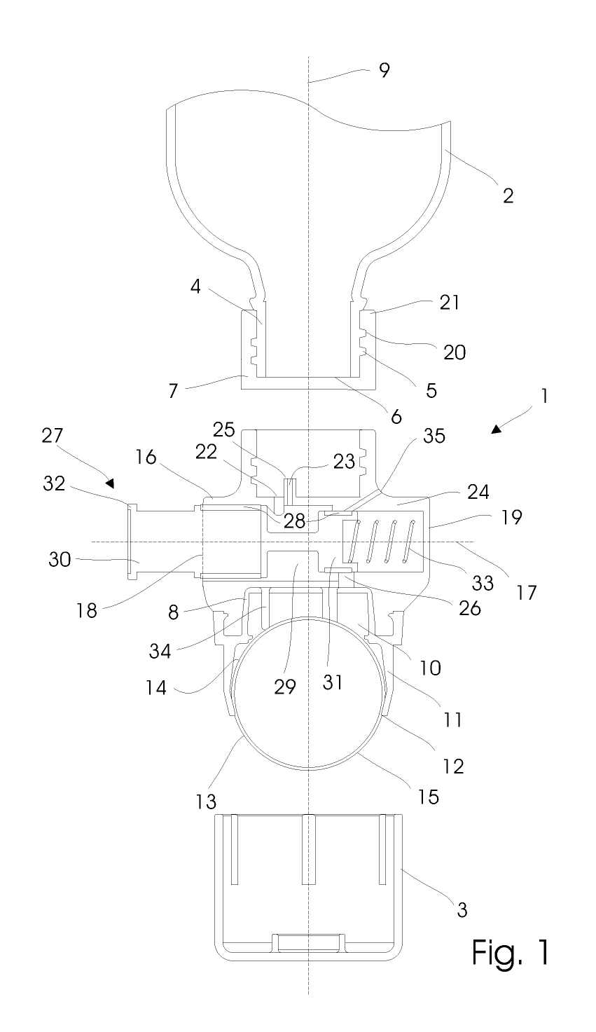

FIG. 1 shows, seen in section, a preferred embodiment of an applicator according to the invention,

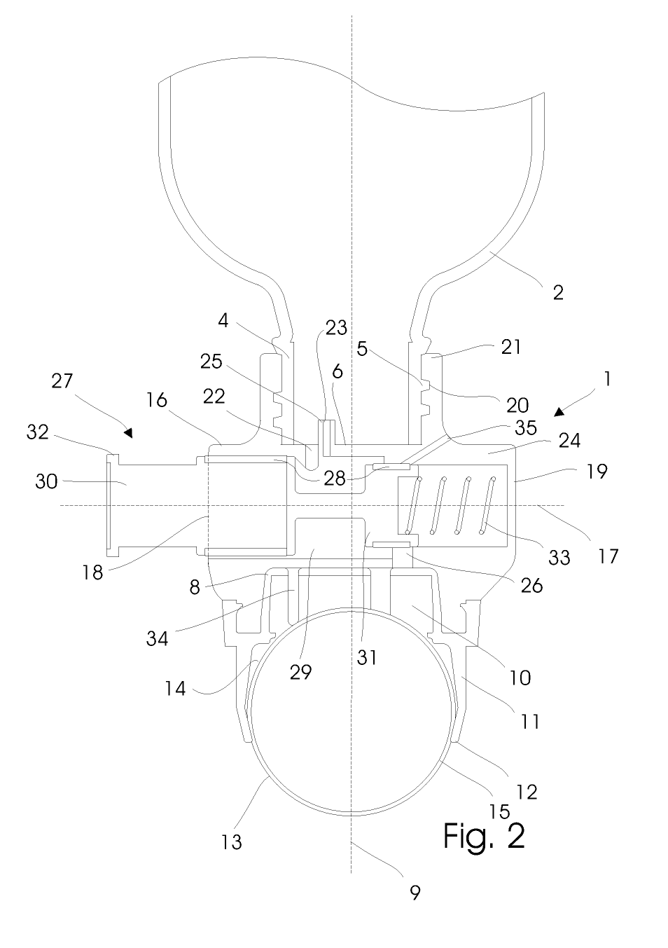

FIG. 2 shows the same in assembled state with a slider placed in a first position in a pipe of the applicator,

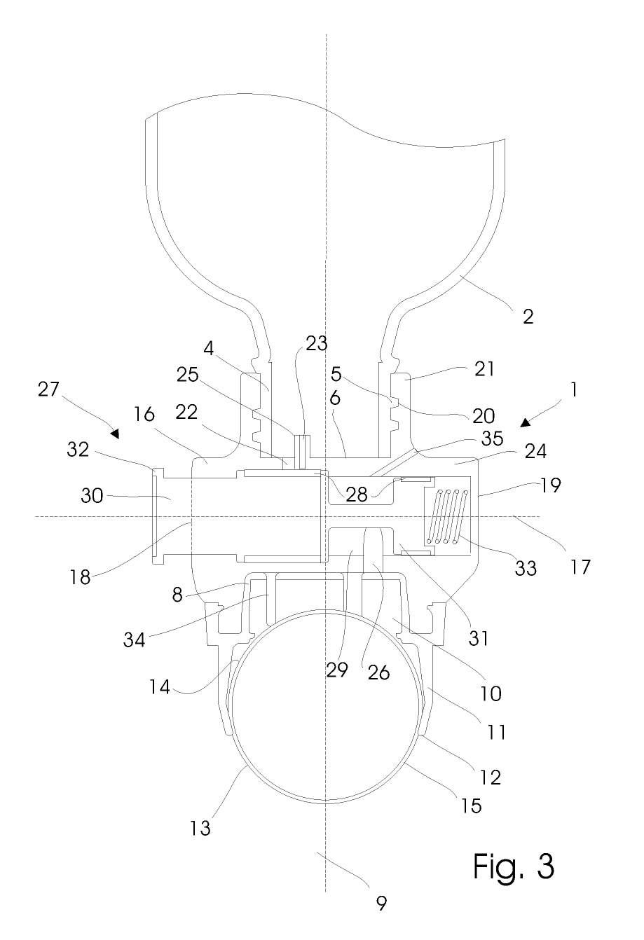

FIG. 3 shows the same as in FIG. 2, but with the slider placed in a second position in the pipe, and

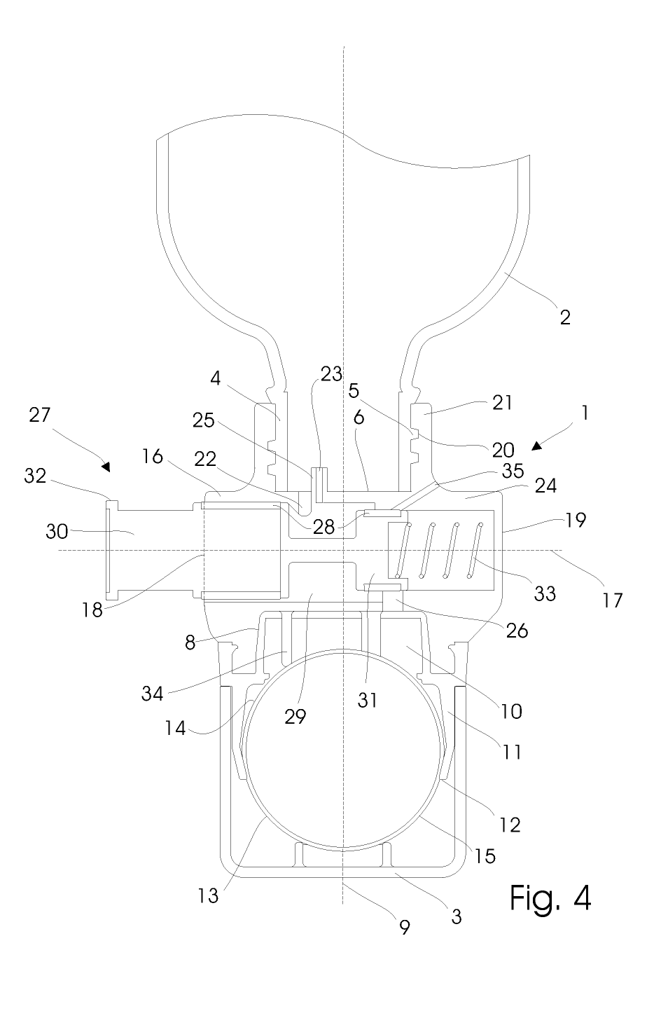

FIG. 4 shows the same as in FIG. 2 but in a resting condition with a protection cap detachable mounted on the housing.

The applicator of the invention is adapted for applying a liquid from a source of liquid to the skin of an individual subject, which may be a human or non-human subject. The applicator can be used for administering any appropriate liquid but is in the following supposed to be used for administering an easy-flowing cosmetic or medical formulation to a human subject.

By way of example can, in this connection, be mentioned the strontium-containing pharmaceutical compositions for treatment of subdermal soft tissue pain disclosed in the applicant's patent publication WO 03/028742, said strontium-containing pharmaceutical compositions are incorporated in the present application by reference.

The exploded view, which is seen in FIG. 1 in section, shows a preferred embodiment of the applicator 1 according to the invention, an only partly shown bottle 2 for containing the easy-flowing cosmetic or medical formulation, which is going to be administered by means of the applicator, and a protection cap 3 for the applicator.

The bottle 1 is preferable made of a transparent material like glass for thereby allowing the human subject to see how much formulation, which at a given moment is left in the bottle. The bottle has a neck 4 with an outer screw thread 5 and an opening 6 tight covered by means of a cap 7.

The applicator 1 comprises a housing 8 defining an axis 9 and delimiting a chamber 10 with formulation during an applying operation. The housing is furthermore formed with a skirt 11 with an edge region 12, which is close to or is abutting a roller 13 for applying the formulation by rolling over the skin of the human subject.

The roller could have any appropriate shape. In the drawing the shape of the roller is spherical. In another embodiment could the roller have an elliptical shape, (not shown).

The edge region 12 of the skirt 11 of the housing 8 separates an adhesion side 14 and a transfer side 15 of the roller defined as those surface areas of the roller, which at a given moment is inside or outside the chamber, respectively.

The roller functions in that way that the formulation in the chamber 10 adheres to the adhesion side of the roller while the transfer side of the roller then transfers the adhered formulation to the skin of the human subject when rolling over the skin since the adhesion force of the formulation to the skin is larger than to the surface of the roller.

The material of the roller is preferable a suitable plastic and the surface of the roller is preferable smooth.

A cylinder 16 with an axis 17 is attached to the housing 8 at the opposite side of the roller 13. The axis 17 of the cylinder is extending perpendicular to the axis 9 of the housing. The cylinder has at one end an opening 18 and at the other end a bottom 19.

In FIG. 2 the cap 7 is removed from the bottle, which then is screwed upon an inner screw thread 20 on a boss 21 on the cylinder 16 by means of the outer screw thread 5 on the neck 4 of the bott

The opening 6 of the bottle is now enclosing an outlet 22 for the liquid in the bottle and a vent 23 for air in the recess of the slider, formed in the wall 24 of the cylinder.

The outlet 22 is closer to the opening of the cylinder than the vent 23, which moreover is extending into the neck of the bottle via a tube 25.

A through hole 26 is formed in the wall of the cylinder at an axial distance from the both the outlet 22 and the vent 23 and at the opposite side of the cylinder, which communicates with the chamber of the housing via said through hole 26.

A slider 27 is arranged for sliding in the cylinder 16 between the first position shown in FIG. 2 and the second position shown in FIG. 3. A seal 28 is arranged between the slider and the inner side of the cylinder

A circumferential recess 29 is formed in the slider. The recess separates a front section 30 and a back section 31 of the slider. The front section 28 extends somewhat out of the opening 18 of the cylinder. The free end of the front section is formed as a button 32.

A pressure spring 31 is moreover acting between the back section 33 of the slider and the bottom 19 of the cylinder.

The roller is hold in position in relation to the housing 8 by means of the skirt 11 and three pins 34, which at one end each is attached to the cylinder 16 and at the other end is close to or is abutting the roller 13.

The adhesion side 14 of the roller 13 is larger than the transfer side 15 for thereby securely preventing the roller from leaving the skirt of the housing.

The applicator functions in the following way by applying e.g. an easy-flowing pharmaceutical composition of the kind which is described in the applicant's patent publication WO 03/028742.

The applicator 1 is brought into the operable state shown in FIGS. 2 and 3 by first screwing the bottle 2 upon the applicator 1 in the way described above.

The applicator is then orientated with the bottle 2 situated above the cylinder 16 or more definite with the outlet 22 placed at a lower level than the easy-flowing pharmaceutical composition in the bottle.

The slider 27 is, in FIG. 2, placed in its first position where the circumferential recess 29 of the slider 27 is communication with the bottle 2 via the outlet 22 and the vent 23. The easy-flowing composition in the bottle then runs down into the recess via the outlet 22 since this hole is placed in a lower level than the composition in the bottle, while the air in the recess simultaneously is displaced into the bottle via the vent 23.

The recess is in this way within a period of seconds filled with an accurate dose of the composition.

The slider 16 is then, by means of a pressure on the button 32 of the slider 16, displaced axially in the cylinder 16 to the second position shown in FIG. 3. The recess is in this position communicating with the chamber 10 of the housing via the through hole 26 whereby the dose of composition in the recess automatically will run down into the chamber via said through hole 26.

The elastic force of the pressure spring 33 thereafter will displace the slider from the position shown in FIG. 3 to the position shown in FIG. 2 where the applicator is ready to meter a new dose of composition into the recess of the slider.

For allowing the slider 27 to be moved to and fro in the cylinder without hindrance from the air in the space between the slider 27 and the bottom 19 of the cylinder is a vent 35 formed in the wall 24 of the cylinder, which vent is connecting said space with the surroundings.

The volume of composition in the chamber is applied to the area of the skin of the human subject to be treated by rolling the roller over this area.

The applied composition is, as mentioned above, easy-flowing and the applied layer on the skin therefore relatively thin. Thereby is obtained the substantial advantage that the skin quickly can absorb the composition which, therefore effectively can perform the desired effect on the said area of the skin.

It could however be necessary to repeat the above-mentioned steps more times until the required amount of composition has been applied to the skin of the human subject.

In most cases, the total volume of composition to be administered is supplied to the chamber of the housing by activation the slider one or more times before the administration to the skin starts.

The applicator is in FIG. 4 in a resting condition with the bottle 3 screwed upon the cylinder 16 of the applicator and the protection cap 3 detachable mounted on the housing.

By, in the above-mentioned way, filling the chamber of the housing with the desired volume of composition and removing the cap the applicator is immediately ready for being used.

### EXAMPLE

A formulation identical to the formulation disclosed in the applicant's International patent application WO 03/028742 and denominated 2PX, is used for treating local subdermal pain. The formulation has the following composition.

A composition containing a strontium concentration in the range of 0.1-20% in a low viscosity fluid containing one or more dermal penetration enhancing agents in concentrations required to enhance penetration of strontium ions into the subdermal soft tissues.

Patients suffering from osteoarthritic pain in the knees used the applicator according to the invention for administering the above mentioned composition.

Each evening a thin layer of 2PX was administered to a sufficient area of the lower extremities to cover an area of 100 cm² covering the complete circumference of the lower extremities in the knee region. The volume required to provide a thin layer of fluid on the skin area was 1 ml, and was transferred from a bottle containing the formulation by pushing the slider twice, each push transferring a dose of 0.5 ml.

The area covered by the formulation appeared dry within a short period following completion of the administration, and most of the patients experienced a strong analgesic effect within 10-30 minutes following administration, and for most of the responders, the effect lasted for 24 hours until pain returned.

By repeated administration each 24 hours, these patients could be maintained in a pain-free condition for at least 4 weeks. For a minority of the responders, pain returned between 12 and 24 hours following 2PX administration. These patients needed administration of 2PX twice daily to obtain a satisfactory, lasting pain reduction.

1.-14. (canceled)

15. An applicator for applying a liquid from a source of liquid to the skin of an individual subject, comprising:
a housing delimiting a chamber;
a roller rotatably mounted in the housing with an adhesion side extending into the chamber and a transfer side extending out of the chamber;
a cylinder attached to the housing and having a wall and at least one first and one second through hole formed in the wall for connecting the cylinder to a source of liquid and to the chamber, respectively, with the through holes axially and angularly displaced in relation to each other;
a slider arranged for sliding between first and second positions in the cylinder, the slider comprising front and back sections and being displaceable from the first position to the second position by the application of pressure to its front section; and
a recess formed in the slider, with the recess communicating with the source of liquid in the first position of the slider via at least one of the through holes and with the chamber in the second position of the slider via at least one other through hole.

16. The applicator according to claim 15 which further comprises a seal arranged between the slider and an inner surface of the wall of the cylinder.

17. The applicator according to claim 15, wherein the recess separates the front and back sections of the slider and the front section partly extends out of an opening at one end of the cylinder, and the applicator further comprises a pressure spring acting between the back section and a bottom at the opposite end of the cylinder.

18. The applicator according to claim 15 wherein at least one of the first through holes in the wall of the cylinder is an outlet for liquid in one position and a vent for air in another position.

19. The applicator according to claim 18, wherein the outlet is closer to the opening of the cylinder than the vent and debouches at a smaller distance from inside the cylinder.

20. The applicator according to claim 15, which further comprises a container for the liquid which is mounted upon the cylinder with an opening enclosing the at least one of the first through holes of the cylinder.

21. The applicator according to claim 15, wherein the pipe cylinder has a circular cross section.

22. The applicator according to claim 15, wherein the housing is formed with a skirt which has an edge region close to or abutting the roller between the adhesion side and the transfer side of the roller.

23. The applicator according to claim 15, wherein the adhesion side of the roller is larger than the transfer side of the roller.

24. The applicator according to claim 22, wherein the position of the roller is defined by the skirt and at least three pins, each of which at one end is attached to the pipe cylinder and at the other end is close to or abutting the roller.

25. A method for applying an easy-flowing liquid to the skin of an individual subject, which comprises applying the liquid from a source of liquid with the use of an applicator according to claim 15.

26. The method according to claim 25 wherein the liquid is a cosmetic or medical formulation.

27. The method according to claim 25 wherein the applicator is connected to the source of the liquid.

28. The method according to claim 25 which further comprises
orienting the applicator in such a way that the at least one first through hole in the wall of the cylinder is placed at a lower level than the source of liquid,
holding the slider in its first position for a predetermined period of time,
displacing the slider from the first to second position by a pressure acting against the elastic force of a pressure spring,
allowing the elastic force of the pressure spring to displace the slider from the second to first position, and
rolling the roller over the skin.

29. The method according to claim 28 wherein the steps are repeated until the required quantity of liquid is applied to the skin.
